(19) United States
(12) Patent Application Publication
(10) Pub. No.: US 2025/0388370 A1
(43) Pub. Date: Dec. 25, 2025

(54) LID OPENING AND CLOSING DEVICE

(71) Applicant: U-Shin Ltd., Nagano (JP)

(72) Inventor: Yohei ISOGAI, Hiroshima City (JP)

(21) Appl. No.: 19/082,293

(22) Filed: Mar. 18, 2025

(30) Foreign Application Priority Data
Jun. 21, 2024 (JP) 2024-100874

(51) Int. Cl. B65D 43/26; B65D 55/12

(52) U.S. Cl. CPC B65D 43/267; B65D 55/12

(57) ABSTRACT

Locking a lid while controlling cost increases. In a lid opening and closing device, an engagement receiver and a lock member is provided on a base and a lid respectively. A base-end portion of a drive-link is rotatably coupled to the base, and a tip-end portion of the drive-link is coupled to the drive-link coupling of the lid. By rotating the drive-link to one side in a rotation direction by an actuator, the lid moves from an open to a closed position to close the opening. The drive-link coupling couples the drive-link to the lid so that a relative rotation of the drive-link to the lid in the closed position is allowed. When the drive-link rotates relative to the lid to said one side in the rotation direction, the lock member is switched to a locked state. This allows the lock member to be in the locked state utilizing the actuator.

### TECHNICAL FIELD

The present invention relates to a lid opening and closing device.

### BACKGROUND ART

In an energy receiving port device (lid opening and closing device) of a following patent literature 1, a lid closes a concave space of a receiving port in an openable manner. The lid is opened and closed by an opening and closing mechanism, and the opening and closing mechanism comprises a link mechanism and a motor. The link mechanism is actuated by the motor, and the lid opens and closes the concave space.

### PATENT LITERATURE

Japanese Unexamined Patent Application Publication No. 2014-210473

### SUMMARY OF INVENTION

### Technical Problem

The energy receiving port device is not equipped with a lock mechanism that prevents the lid from moving when the lid is closed. Therefore, from a viewpoint of increasing a safety of the energy receiving port device, it is desirable to provide the lock mechanism in the energy receiving port device. For example, by providing the lock mechanism with a lock member that prevents the lid in a closed state from moving and a driver such as the motor that drives the lock member, the lid can be maintained in the closed state. In other words, by switching the lock member to a locked state to lock the lid or an unlocked state to unlock the lid by a driving force of a driving member, the safety of the energy receiving port device can be improved.

In this case, however, a separate driver to drive the lock member must be provided. This causes an increase in a cost of the energy receiving port device.

The present invention takes the above-mentioned facts into consideration to provide the lid opening and closing device that can lock the lid while controlling a cost increase.

### Solution to Problem

One or more embodiments of the invention is a lid opening and closing device comprising:
a base provided inside an opening in a panel of a vehicle;
a lid configured to be movable between an open position in which the opening is opened and a closed position in which the opening is closed;
an engagement receiver provided on one side of the base and the lid;
a lock member provided on other side of the base and the lid, which, when activated in the closed position of the lid, engages the engagement receiver to switch between a locked state in which the lid is prevented from moving and an unlocked state in which the engagement receiver is disengaged from the engagement receiver;
a driver provided inside the panel;
a link whose base-end portion is rotatably coupled to the base and whose tip-end portion is coupled to the lid, and which moves the lid from the open position to the closed position by being rotated around the base-end portion to one side in direction of rotation by a driving force of the driver; and
a coupling provided on the lid and couples the tip-end portion of the link, wherein,
the coupling couples the tip-end portion of the link to the lid so as to allow the link to rotate relative to the lid in the closed position; and
in the closed position, the lock member is actuated by the link that rotates relative to the lid to said one side in the direction of rotation to switch from the unlocked state to the locked state.

### Advantageous Effect of Invention

According to one or more embodiments of the invention, the lid can be locked while controlling a cost increase.

### BRIEF DESCRIPTION OF DRAWINGS

FIG. 1 is a rear view from a rear of a vehicle schematically illustrating a lid opening and closing device according to a first embodiment.

FIG. 2 is an enlarged rear view of an area around a drive-link coupling of a lid illustrated in FIG. 1.

FIG. 3A is the rear view of a state in which a drive-link illustrated in FIG. 1 has rotated to one side in direction of rotation and the lid has moved to a closed position, and FIG. 3B is the rear view of the state in which the drive-link has rotated further to said one side in the direction of rotation and the lid is disposed in the closed position.

FIG. 4A is the enlarged rear view of the area around the drive-link coupling illustrated in FIG. 3B, FIG. 4B is the rear view of the drive-link in FIG. 4A rotated relative to the lid to said one side in the direction of rotation, and FIG. 4C is the rear view of the state in which the drive-link in FIG. 4B is further rotated relative to the lid to said one side in the direction of rotation and disposed in a lock drive position.

FIG. 5 is a rear view from a rear of a vehicle schematically illustrating a lid opening and closing device according to a second embodiment.

FIG. 6 is an enlarged rear view of an area around a drive-link coupling of a lid illustrated in FIG. 5.

FIG. 7A is the enlarged rear view of the area around the drive-link coupling when the lid illustrated in FIG. 5 is disposed in a closed position, FIG. 7B is the rear view of a drive-link in FIG. 7A that has rotated relative to the lid to one side in direction of rotation, and FIG. 7C is the rear view of a state in which the drive-link in 7B is further rotated relative to the lid to said one side in the direction of rotation and disposed in a lock drive position.

FIG. 8 is a rear view from a rear of a vehicle schematically illustrating a lid opening and closing device according to a third embodiment.

FIG. 9 is an enlarged rear view of an area around a drive-link coupling of a lid illustrated in FIG. 8.

FIG. 10A is the enlarged rear view of the area around the drive-link coupling when the lid illustrated in FIG. 8 is disposed in a closed position, FIG. 10B is the rear view of the drive-link in FIG. 10A that has rotated relative to the lid to one side in direction of rotation, and FIG. 10C is the rear view of a state in which the drive-link in FIG. 10B is further rotated relative to the lid to said one side in the direction of rotation and disposed in a lock drive position.

### DESCRIPTION OF EMBODIMENT

### First Embodiment

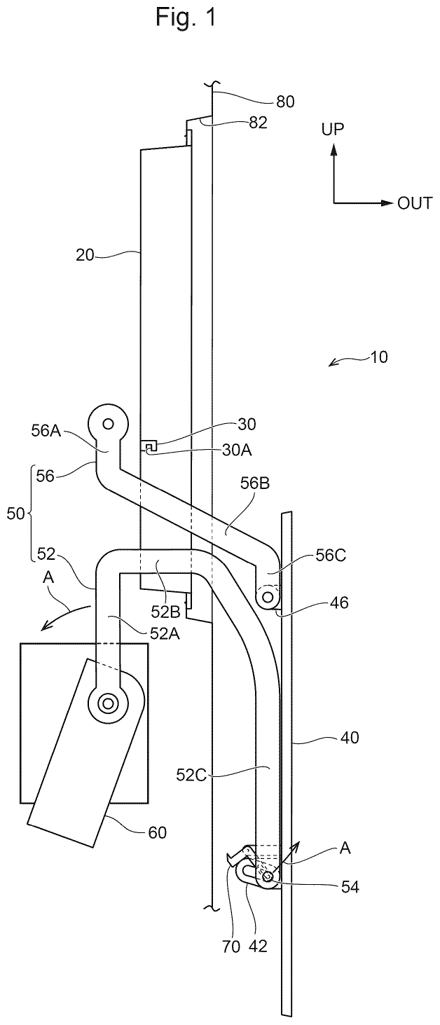

A lid opening and closing device 10 according to a first embodiment is described below using FIG. 1 to FIG. 4. An arrow UP in figures indicates an upper side of a vehicle to which the lid opening and closing device 10 is applied, and an arrow OUT indicates an outside of the vehicle in vehicle-width direction. The upper side of a paper in the figure coincides with a rear side of the vehicle.

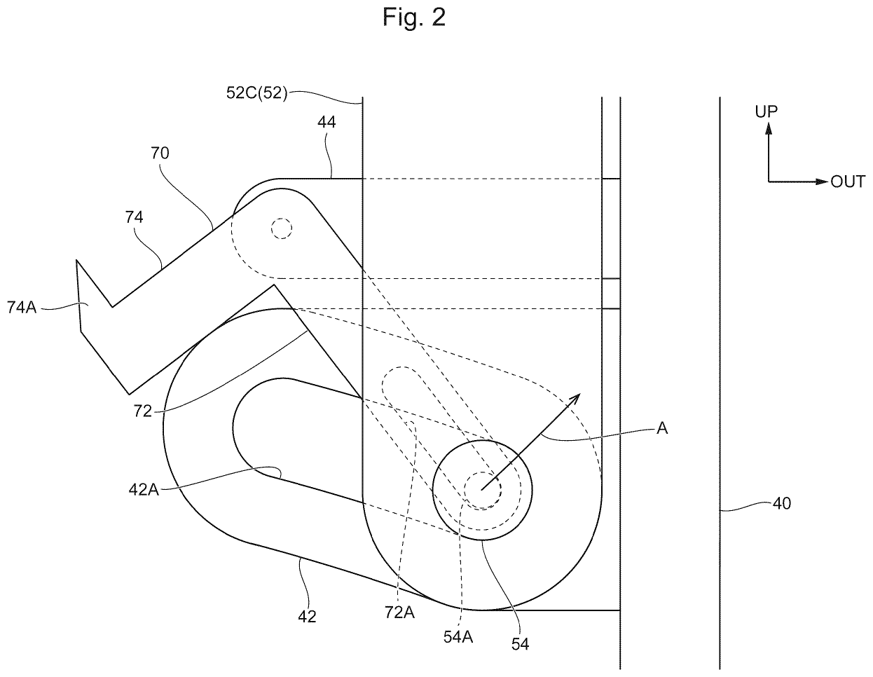

As illustrated in FIG. 1 and FIG. 2, the lid opening and closing device 10 is provided at a side of a rear of the vehicle (in the example illustrated in FIG. 1, at a right side portion of the vehicle). The lid opening and closing device 10 comprises a base 20, an engagement receiver 30, a lid 40, a link mechanism 50, and a lock member 70. Each of components of the lid opening and closing device 10 will be described below.

### Base 20

The base 20 is provided on an inner side in the vehicle-width direction of an opening 82 provided in an outer panel 80 as a panel of the vehicle. The base 20 is formed in a concave shape open to the outside of the vehicle-width direction. The base 20 is provided with an energy receiver, not illustrated in the figure, and a portion of the energy receiver is exposed from the base 20 to an outer-side in the vehicle-width direction.

### Engagement Receiver 30

The engagement receiver 30 is provided at a bottom of a bottom wall of the base 20 on an outer side surface in the vehicle-width direction. The engagement receiver 30 is formed in a shape of a substantially U-shaped block that is open to a lower side when viewed from the rear side. In other words, a lower surface of the engagement receiver 30 has a receiving recess 30A that is open to the lower side in a middle of the vehicle-width direction.

### Lid 40

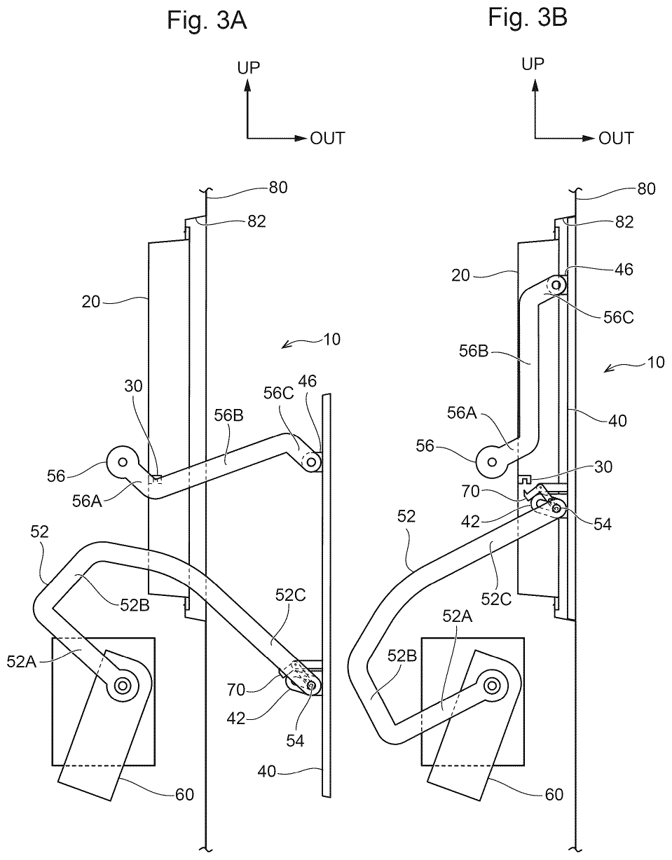

The lid 40 is formed in a substantially plate shape with the vehicle-width direction as plate thickness direction. The lid 40 is configured to be movable between an open position (position illustrated in FIG. 1), which opens the opening 82, and a closed position (position illustrated in FIG. 3B), which closes the opening 82, by the link mechanism 50 described further below. The following description is based on the lid 40 in the open position. On a back surface of the lid 40 (inner side surface in the vehicle-width direction), a drive-link coupling 42 is provided as a coupling to couple a drive-link 52, described further below, in a rotatable and relatively movable manner at the bottom. The drive-link coupling 42 has a coupling groove 42A formed through in front-back direction, and the coupling groove 42A is formed in a long-hole-shape extending in a substantially vehicle-width direction in a rear view. Specifically, the coupling groove 42A extends along direction slightly inclined downwardly toward the outside of the vehicle-width direction, and is formed in the shape of an arc extending around a base-end side axis of the drive-link 52.

On the back surface of the lid 40, a lock supporter 44 is provided above the drive-link coupling 42 to rotatably support the lock member 70 described further below. The lock supporter 44 extends from the lid 40 inwardly in the vehicle-width direction. On the back surface of the lid 40, a driven-link coupling 46 is provided at an upper portion for rotatably couple a driven-link 56 described further below. The-driven-link coupling 46 extends from the lid 40 inwardly in the vehicle-width direction.

### Link Mechanism 50

The link mechanism 50 is a mechanism that couples the base 20 and the lid 40 and moves the lid 40 between the open and closed positions when activated. The link mechanism 50 comprises the drive-link 52 as a link and the driven-link 56. The drive-link 52 is formed in a substantially long plate shape with the front-back direction as the plate thickness direction, and is formed in a substantially U-shape open to the lower side in the rear view. Specifically, the drive-link 52 comprises a base side link 52A extending in vertical direction, a middle link 52B extending outward from an upper end portion of the base side link 52A in the vehicle-width direction, and a tip side link 52C extending downward from a tip-end portion of the middle link 52B. A middle portion in the vehicle-width direction of the middle link 52B is bent outward and downward in the vehicle-width direction.

A lower end portion of the base side link 52A (base-end portion of the drive-link 52) is rotatably coupled to the base 20 with the front-back direction as the axial direction on the inner side in the vehicle-width direction of the outer panel 80. In other words, although the figure is omitted, the base 20 is extended to the position where the lower end portion of the base side link 52A is coupled. The middle link 52B is disposed within the lower end portion of the base 20, and the outer portion in the vehicle-width direction of the middle link 52B protrudes outwardly in the vehicle-width direction from the opening 82. The base 20 has an insertion hole (not illustrated) through which the drive-link 52 and the driven-link 56 are inserted. The tip side link 52C is adjacent to the inner side in the vehicle-width direction of the lid 40.

A link shaft 54 is provided at the lower end portion of the tip side link 52C (the tip-end portion of the drive-link 52). The link shaft 54 is formed in a substantially stepped cylindrical shape with the front-back direction as the axial direction and has a small diameter portion 54A in the middle portion of the axial direction. The link shaft 54 rotates together with the drive-link 52 around the base-end portion of the drive-link 52. In other words, link shaft 54 configures a portion of the drive-link 52. The link shaft 54 is inserted within one end portion (outer end portion in the vehicle-width direction) of the coupling groove 42A of the lid 40. The link shaft 54 is rotatably supported in said one end portion of the coupling groove 42A and is configured to be movable in a longitudinal direction of the coupling groove 42A. In the following description, a state of the drive-link 52 when the link shaft 54 is disposed at said one end portion of the coupling groove 42A is referred to as a lock non-driven state.

The driven-link 56 is formed in the substantially long plate shape with the front-back direction as the plate thickness direction and is substantially crank-shaped in the rear view. Specifically, the driven-link 56 comprises a base side link 56A extending in the vertical direction, a middle link 56B extending from the lower end portion of the base side link 56A along direction sloping downwardly toward the outside of the vehicle-width direction, a tip side link 56C extending downwardly from an outside end portion of the middle link 56B in the vehicle-width direction.

The driven-link 56 is disposed above the drive-link 52. An upper end portion of the base side link 56A of the driven-link 56 (the base-end portion of the driven-link 56) is rotatably coupled to the base 20 with the front-rear direction as axis direction on the inner side of the outer panel 80 in the vehicle-width direction. In other words, similarly to the drive-link 52, the base 20 is extended to the position where the upper end portion of the base side link 56A is coupled. A coupled position of the base-end portion of the driven-link 56 to the base 20 in the vehicle-width direction and the coupled position of the base-end portion of the drive-link 52 to the base 20 are substantially coincident. The tip side link 56C is adjacent to the upper end portion of the lid 40 on the inner side in the vehicle-width direction, and the lower end portion of the tip side link 56C (the tip-end portion of the driven-link 56) is rotatably coupled to the driven-link coupling 46 of the lid 40 in the front-back direction as the axis direction. The coupled position of the tip-end portion of the driven-link 56 to the lid 40 in the vehicle-width direction and the coupled position of the tip-end portion of the driven-link 52 to the lid 40 are substantially coincident. As above, the link mechanism 50 is configured as a so-called 4-node link, and when activated, the lid 40 moves between the open and closed positions.

An actuator 60 as a driver is coupled to the base-end portion of the drive-link 52. The actuator 60 is electrically connected to a controller, not illustrated in the figure, and when the actuator 60 is driven by the controller, the drive-link 52 rotates around the base-end portion to activate the link mechanism 50. In detail, the lid 40 moves from the open position to the closed position when the drive-link 52 is rotated to one side in the direction of rotation (arrow A in FIG. 1 and FIG. 2).

Here, in a position other than the closed position of the lid 40, the coupling groove 42A is extended along the direction crosswise to the direction of rotation of the link shaft 54 in the rear view (see FIG. 2). As a result, when the lid 40 moves between the open and closed positions, the drive-link 52 rotates about the base-end portion while maintaining the lock non-driven state.

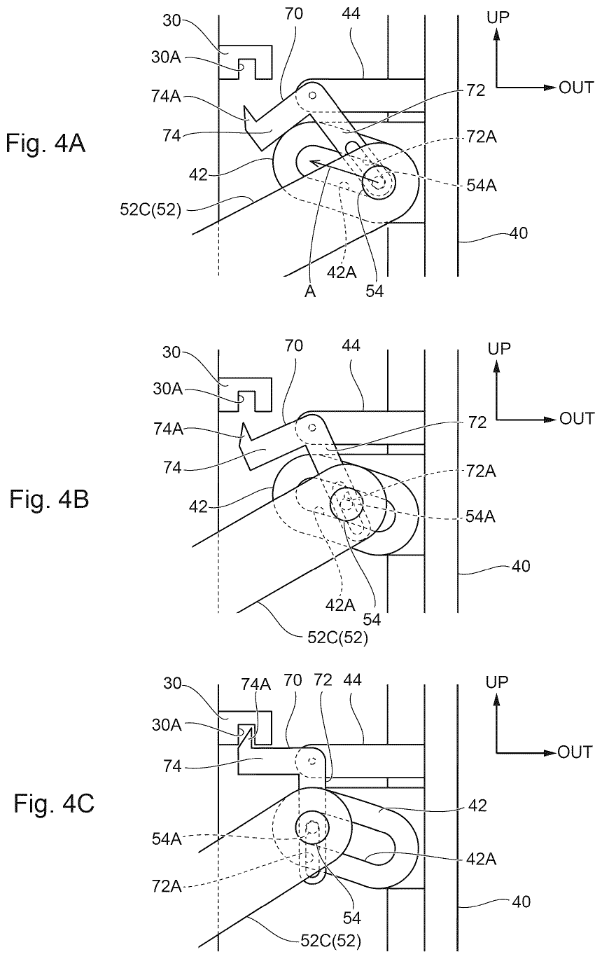

On the other hand, in the closed position of the lid 40, the coupling groove 42A is extended along rotational direction of the link shaft 54 in the rear view (see FIG. 4A). In other words, the coupling groove 42A extends from the link shaft 54 to said one side of the rotational direction of the drive-link 52. As a result, in the closed position of the lid 40, it is configured so that the coupling groove 42A allows the link shaft 54 to move to other end portion side of the coupling groove 42A. In other words, the drive-link coupling 42 couples the tip-end portion of the drive-link 52 to the lid 40 so that the drive-link 52 is allowed to rotate relative to the lid 40 in the closed position of the lid 40. Therefore, by driving the actuator 60, the drive-link 52 is rotated relative to the lid 40 to one side in the direction of rotation, and the link shaft 54 is disposed at other end portion (inner side end portion in the vehicle-width direction) of the coupling groove 42A (the state illustrated in FIG. 4C. Hereafter, this state of the drive-link 52 is referred to as a “lock driven state”). In the lock driven state of the drive-link 52, the drive-link 52 is switched to the lock non-driven state by rotating the drive-link 52 to other side in the direction of rotation by driving the actuator 60.

### Lock Member 70

As illustrated in FIG. 2, the lock member 70 is formed in a substantially V-shape, open to the bottom in the rear view. Specifically, the lock member 70 comprises a lock coupling 72 extending along the direction sloping outwardly in the vehicle-width direction toward the lower side, and a lock 74 extending from the upper end portion of the lock coupling 72 in the direction sloping downwardly in the vehicle-width direction toward the inner side.

The upper end portion of the lock coupling 72 is rotatably coupled to the inner side end portion of the lock supporter 44 of the lid 40 in the vehicle-width direction with the front-back direction as the axis direction. As a result, the lock member 70 is provided on the lid 40 in a rotatable manner. A slide groove 72A is formed through the lower end portion of the lock coupling 72 in the front-back direction, and the slide groove 72A is formed in the long-hole-shape extending along the longitudinal direction of the lock coupling 72. The small diameter portion 54A of the above-mentioned link shaft 54 is movably inserted into the slide groove 72A and is disposed at the lower end portion of the slide groove 72A. As a result, the lock member 70 is coupled to the drive-link 52. A hook 74A is formed at the tip-end portion of the lock 74, and the hook 74A protrudes upward from the lock 74.

In the closed position of the lid 40, the drive-link 52 switches to the lock non-driven or lock driven state, and the lock member 70 coupled to the link shaft 54 rotates around the upper end portion of the lock coupling 72. Specifically, the lock member 70 rotates between an unlocked position (the position illustrated in FIG. 2 and FIG. 4A) and a locked position (the position illustrated in FIG. 4C). In the locked position of the lock member 70, the link shaft 54 is disposed at the upper end portion of the slide groove 72A.

Furthermore, as illustrated in FIG. 4A, in the unlocked position of the lock member 70 in the closed position of the lid 40, the hook 74A is disposed spaced apart from the bottom of the receiving recess 30A of the engagement receiver 30. Therefore, the lock member 70 and the engagement receiver 30 are not engaged, and the lock member 70 is in an unlocked state (a state in which movement of the lid 40 outward in the vehicle-width direction is permitted). On the other hand, as illustrated in FIG. 4C, in the closed position of the lid 40, the lock member 70 is rotated from the unlocked position to the locked position, and the hook 74A is configured to insert into the receiving recess 30A of the engagement receiver 30. As a result, the lock member 70 and the engagement receiver 30 are engaged in the vehicle-width direction, and the lock member 70 is configured to be in a locked state (a state in which movement of the lid 40 to the outside of the vehicle-width direction is prevented).

### Effects

Next, actions and effects of the present embodiment will be described.

In the lid opening and closing device 10 configured as described above, the lid 40 is disposed outside the outer panel 80 of the vehicle in the vehicle-width direction in the open position, and the opening 82 is opened outward in the vehicle-width direction (see FIG. 1). In this state, the link shaft 54 is disposed at said one end portion of the coupling groove 42A of the lid 40, and the lock member 70 is disposed in the unlocked position. The coupling groove 42A is extended along the direction that intersects the direction of rotation of the link shaft 54 in the rear view.

To move the lid 40 to the closed position, the actuator 60 rotates the drive-link 52 to one side in the direction of rotation to activate the link mechanism 50. Specifically, as illustrated in FIG. 3A, the drive-link 52 rotates around the base-end portion to one side in the direction of rotation and the driven-link 56 rotates around the base-end portion to one side in the direction of rotation, causing the lid 40 to be displaced inward and upward from the open position in the vehicle-width direction while maintaining the plate thickness direction as the vehicle-width direction.

As illustrated in FIG. 3B and FIG. 4A, when the lid 40 reaches the closed position, the opening 82 is closed by the lid 40. In this state, the lock non-driven state of the drive-link 52 is maintained and the link shaft 54 is disposed at said one end portion of the coupling groove 42A. The hook 74A of the lock member 70 is disposed in the lower side of the receiving recess 30A of the engagement receiver 30, and the unlocked state of the lock member 70 is maintained. Furthermore, the coupling groove 42A is extended along the rotational direction of the link shaft 54 in the rear view, and the drive-link 52 is allowed to rotate to said one side in the rotational direction.

Therefore, as illustrated in FIG. 4B, the actuator 60 rotates the drive-link 52 relative to the lid 40 to said one side in the direction of rotation. As a result, the link shaft 54 moves to the other end of the coupling groove 42A and the lock member 70 coupled to the link shaft 54 rotates toward the locked position. In other words, the lock member 70 operates in conjunction with a relative rotation of the drive-link 52 to the lid 40.

As illustrated in FIG. 4C, when the drive-link 52 reaches a lock drive position, the lock member 70 is disposed in the lock position. Thereby, the hook 74A of the lock member 70 is inserted from the lower side into the receiving recess 30A of the engagement receiver 30, and the lock member 70 and the engagement receiver 30 are engaged in the vehicle-width direction. Accordingly, the lock member 70 is in the locked state and the lid 40 is prevented from moving outward in the vehicle-width direction. Even if the lid 40 is manually operated to an open side in this locked state, the link shaft 54 of the drive-link 52 continues to be positioned at the other end of the coupling groove 42A, so a positional relationship between the lid 40 and the drive-link 52 remains the same. As a result, the lock member 70 also remains in the locked state, so the engagement between the lock member 70 and the engagement receiver 30 will not be disengaged.

As explained above, in the lid opening and closing device 10, the engagement receiver 30 is provided on the base 20 and the lock member 70 is provided on the lid 40 in the rotatable manner. The base-end portion of the drive-link 52 is rotatably coupled to the base 20, and the tip-end portion of the drive-link 52 is coupled to the drive-link coupling 42 of the lid 40. By rotating the drive-link 52 to said one side in the direction of rotation by the actuator 60 in the open position of the lid 40, the lid 40 moves to the closed position to close the opening 82. Here, the drive-link coupling 42 couples the tip-end portion of the drive-link 52 to the lid 40 so as to allow the relative rotation of the drive-link 52 to the lid 40 in the closed position of the lid 40. Specifically, the link shaft 54 of the drive-link 52 is inserted into said one end portion of the long-hole-shaped coupling groove 42A of the drive-link coupling 42, and the coupling groove 42A is extended to allow the relative rotation of the drive-link 52 to the lid 40 to said one side in the direction of rotation. When the drive-link 52 is rotated relative to the lid 40 to said one side in the direction of rotation, the link shaft 54 of the drive-link 52 moves the lock member 70 from the unlocked position to the locked position to engage with the engagement receiver 30. In other words, the lock member 70 switches from the unlocked state to the locked state. This allows the lock member 70 to switch from the unlocked state to the locked state by utilizing the actuator 60 for opening and closing the lid 40. In other words, there is no need to provide a separate drive source to drive the lock member 70. Therefore, the lid 40 can be locked while controlling a cost increase.

As mentioned above, the drive-link coupling 42 of the lid 40 has the long-hole-shaped coupling groove 42A. The link shaft 54 of the drive-link 52 is movably inserted into the coupling groove 42A and is disposed at said one end portion of the coupling groove 42A. In the closed position of the lid 40, the coupling groove 42A is extended along the direction of rotation of the link shaft 54 in the rear view. That is, in the closed position of the lid 40, the coupling groove 42A is extended to allow the movement of the link shaft 54 from said one end portion of the coupling groove 42A to the other end. This allows the drive-link 52 to be switched to the lock non-driven or lock driven state while maintaining the lid 40 in the closed position.

In positions other than the closed position of the lid 40, the coupling groove 42A extends along the direction crosswise to the direction of rotation of the link shaft 54 in the rear view. This allows the drive-link 52 to be rotated around its own base-end portion to move the lid 40 between the open and closed positions while maintaining the lock non-driven state of the drive-link 52.

The lock member 70 comprises the lock 74, which is rotatably coupled to the lid 40 and is configured to be able to engage the engagement receiver 30, and the lock coupling 72, which is coupled to the link shaft 54. Specifically, the link shaft 54 is movably inserted into the slide groove 72A of the lock coupling 72. When the drive-link 52 switches from the lock non-driven state to the lock driven state in the closed position of the lid 40, the lock member 70 is rotated by the link shaft 54 to engage the hook 74A of the lock 74 with the receiving recess 30A of the engagement receiver 30 in the vehicle-width direction. This allows the lock member 70 provided on the lid 40 to engage the engagement receiver 30 with a simple configuration.

### Second Embodiment

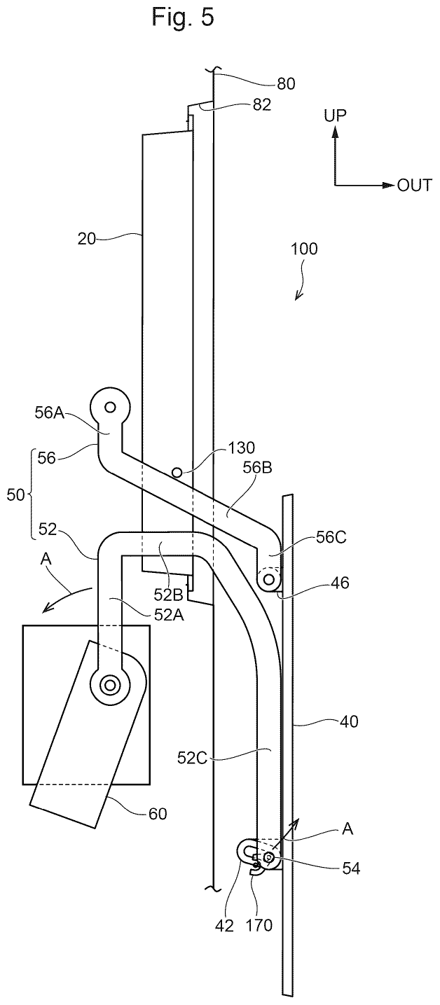

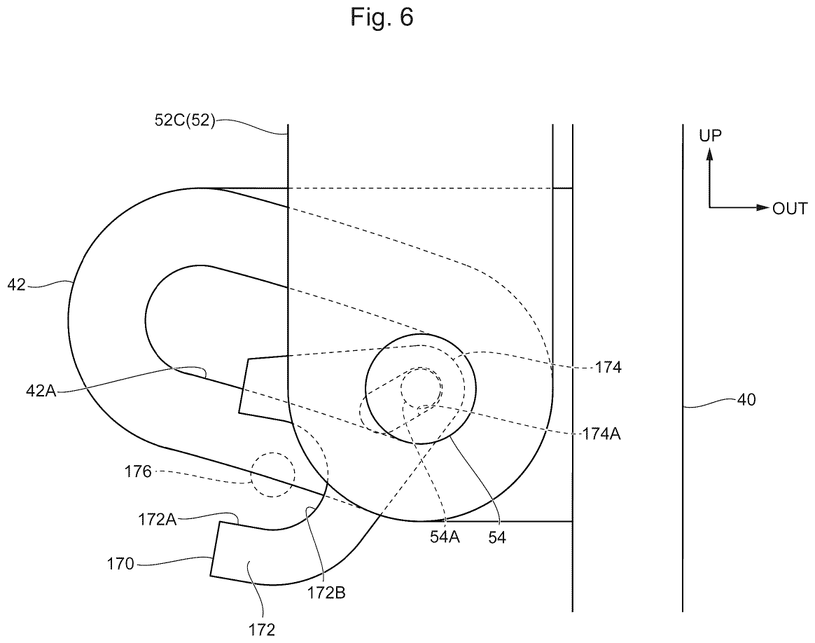

A lid opening and closing device 100 of a second embodiment is described below using FIG. 5 to FIG. 7. The lid opening and closing device 100 of the second embodiment is configured in the same manner as a lid opening and closing device 10 of a first embodiment, except for the following points. In FIG. 5 to FIG. 7, members similarly configured to the lid opening and closing device 10 of the first embodiment are marked with the same symbols.

In the second embodiment of the lid opening and closing device 100, an engagement pin 130 as an engagement receiver is provided on a base 20 instead of an engagement receiver 30. The engagement pin 130 is formed in a substantially cylindrical shape with front-back direction as axial direction and is provided at a bottom of the base 20.

In the lid opening and closing device 100, a lock member 170 is provided on a lid 40 instead of a lock member 70. The lock member 170 comprises a lock 172 and a lock coupling 174. The lock 172 is formed in a substantially U-shaped block that is opened inwardly in vehicle-width direction in a rear view. That is, the lock 172 has a lock recess 172A open toward inside of the vehicle-width direction, and a bottom surface 172B of the lock recess 172A is formed in an arc-shape. A width dimension of the lock recess 172A is set slightly larger than a diameter of the engagement pin 130. The lock 172 is rotatably coupled to a drive-link coupling 42 of the lid 40 by a lock coupling shaft 176 having the front-back direction as its axis direction. The lock coupling shaft 176 is located below a longitudinal middle portion of the coupling groove 42A. The position of the lock coupling shaft 176 is set so that an axis line of the lock coupling shaft 176 coincides with a center of an arcuate bottom surface 172B in the lock recess 172A in the rear view.

The lock coupling 174 protrudes outward in the vehicle-width direction from the upper portion of the lock 172 in the rear view. The lock coupling 174 has a slide groove 174A extending along substantially vehicle-width direction and penetrating in front-back direction. Specifically, the slide groove 174A extends along direction sloping upwardly as it moves outwardly in the vehicle-width direction. A small diameter portion 54A of a link shaft 54 of a drive-link 52 is movably inserted into the slide groove 174A and is disposed within one end portion of the slide groove 174A (an outer end in the vehicle-width direction).

Also in the second embodiment, the lid 40 is disposed outside in the vehicle-width direction of an outer panel 80 of the vehicle in an open position, and an opening 82 is open to the outside in the vehicle-width direction. The lid 40 is moved from the open position to a closed position by a link mechanism 50 driven by an actuator 60.

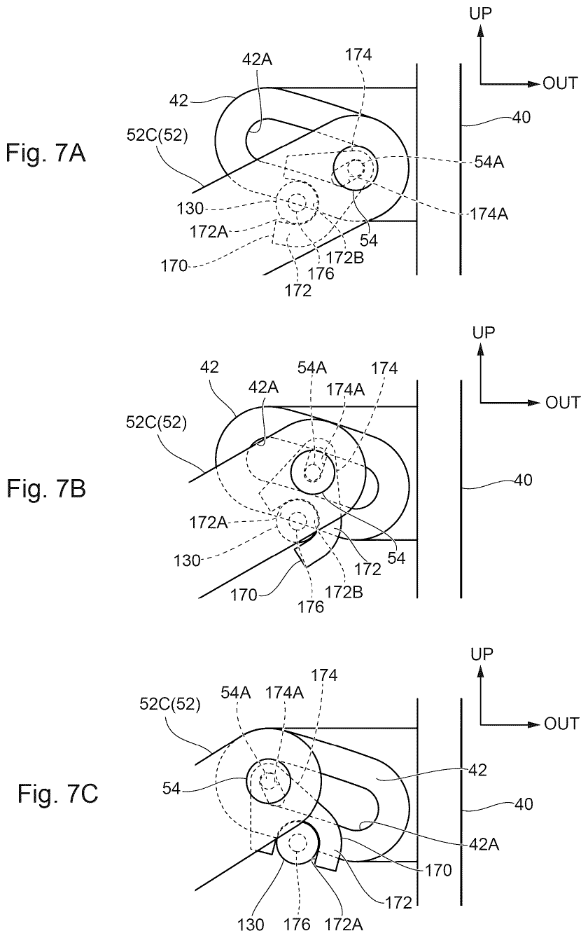

As illustrated in FIG. 7A, in the closed position of the lid 40, the engagement pin 130 is inserted into a lock recess 172A of the lock member 170 from the inside in the vehicle-width direction. In this state, the lock coupling shaft 176 of the lock member 170 is coaxially disposed with the engagement pin 130. Furthermore, in this state, the lock recess 172A is open to the inside in the vehicle-width direction, thus allowing movement of the lock member 170 to the outside in the vehicle-width direction with respect to the engagement pin 130. As a result, the lock member 170 is in an unlocked state. As in the first embodiment, the drive-link 52 is allowed to switch from a lock non-driven state to a lock driven state since the coupling groove 42A is extended along the direction of rotation of the link shaft 54 in the rear view.

Therefore, as illustrated in FIG. 7B, the link shaft 54 moves to other end of the coupling groove 42A by driving the actuator 60 to rotate the drive-link 52 relative to the lid 40 to one side in the direction of rotation. At this time, the lock member 170 coupled to the link shaft 54 rotates to said one side (counterclockwise in the rear view) around an axis of the lock coupling shaft 176 (engagement pin 130). In other words, the lock member 170 actuates in conjunction with a relative rotation of the drive-link 52 to the lid 40.

As illustrated in FIG. 7C, when the drive-link 52 switches to the lock driven state, the lock member 170 is disposed in a position where the lock recess 172A of the lock member 170 opens to a lower side. As a result, the lock member 170 and the engagement pin 130 are engaged in the vehicle-width direction. As a result, the lock member 170 switches to a locked state and the lid 40 is prevented from moving outward in the vehicle-width direction. Even if the lid 40 is manually operated to an open side in this locked state, the link shaft 54 of the drive-link 52 continues to be located at the other end of the coupling groove 42A, so a positional relationship between the lid 40 and the drive-link 52 remains unchanged. As a result, the lock member 170 also remains in the locked state, so the engagement between the lock member 170 and the engagement pin 130 will not be disengaged.

As described above, in the second embodiment, as in the first embodiment, the lock member 170 can be rotated from the unlocked position to the locked position by utilizing the actuator 60 for opening and closing the lid 40. Therefore, also in the second embodiment, the lid 40 can be locked while controlling a cost increase.

In the second embodiment, the lock member 170 comprises a lock 172 having the lock recess 172A and the lock coupling 174 having the long-hole-shaped slide groove 174A. In the closed position of the lid 40, the engagement pin 130 is inserted into the lock recess 172A and the link shaft 54 is inserted into the slide groove 174A so as to be relatively movable. Furthermore, in the closed position of the lid 40, the lock coupling shaft 176 of the lock member 170 and the engagement pin 130 are coaxially disposed. When the drive-link 52 switches from the lock non-driven state to the driven state, the lock member 170 rotates around the axis of the engagement pin 130, causing the lock 172 to engage the engagement pin 130 in the vehicle-width direction and the lock member 170 to switch from the unlocked state to the locked state. As in the first embodiment, this allows the lock member 70 provided on the lid 40 to engage the engagement receiver 30 pin 130 with a simple configuration.

### Third Embodiment

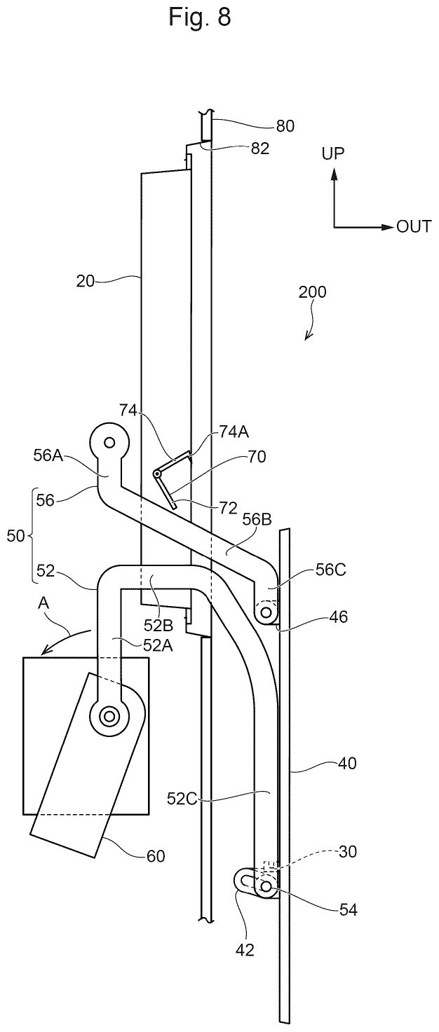

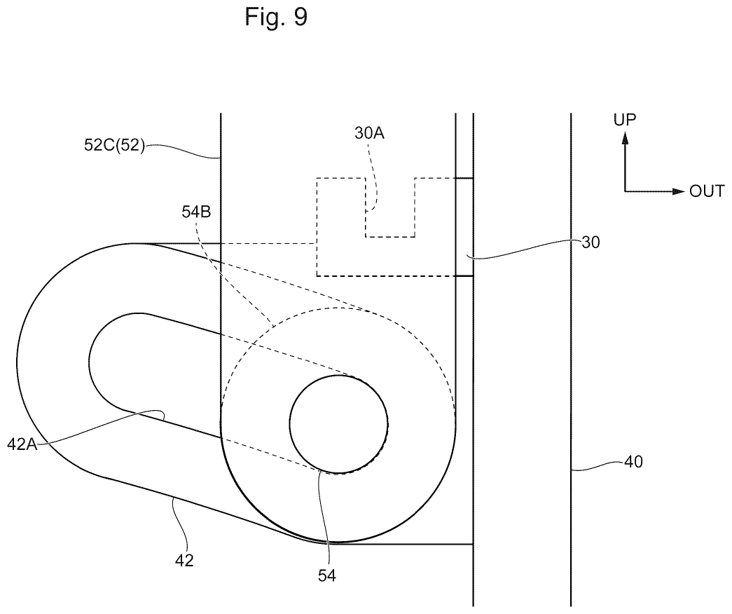

A third embodiment of a lid opening and closing device 200 will be described below using FIG. 8 to FIG. 10. The lid opening and closing device 200 of the third embodiment is configured in the same manner as a lid opening and closing device 10 of a first embodiment, except for the following points. In FIG. 8 to FIG. 10, members similarly configured to the lid opening and closing device 10 of the first embodiment are marked with the same symbols.

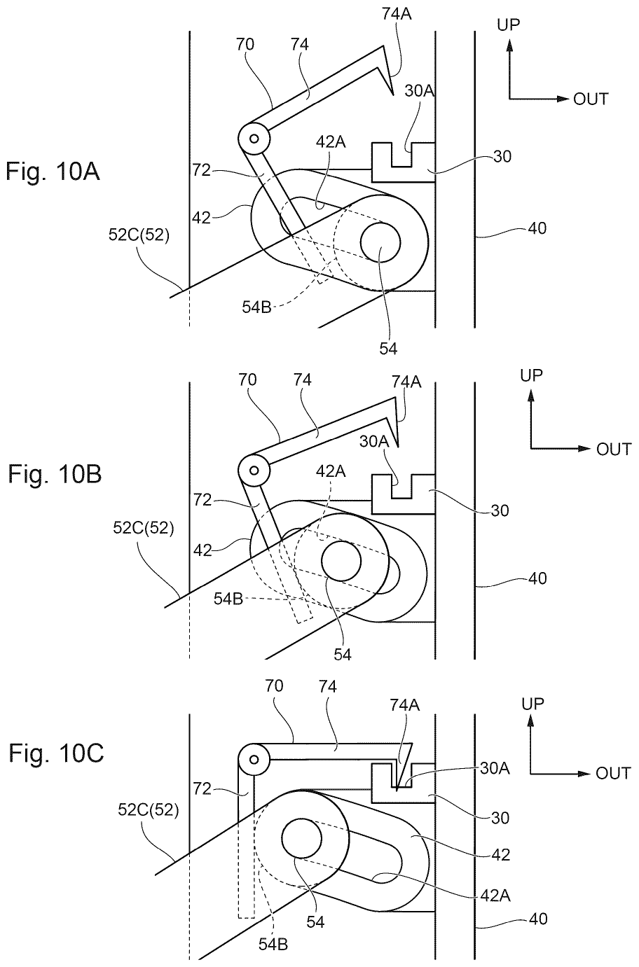

In the third embodiment of the lid opening and closing device 200, a lock member 70 is provided at a bottom of a base 20. In the third embodiment, a lock coupling 72 of the lock member 70 is extended along direction sloping outward in vehicle-width direction toward a lower side, and an upper end portion of the lock coupling 72 is rotatably coupled to the base 20 with front-back direction as axis direction. A lock 74 of the lock member 70 is extended from the upper end portion of the lock coupling 72 in the direction sloping upwardly as it moves outward in the vehicle-width direction, and a hook 74A protrudes downwardly from a tip-end portion of the lock 74. This allows the lock member 70 to be coupled to the base 20 in such a way that it can rotate between an unlocked position (illustrated in FIG. 8 and FIG. 10A) and a locked position (illustrated in FIG. 10C). The lock member 70 is urged toward the unlocked position by a force member not illustrated in the figure, and the lock member 70 is held in the unlocked position.

In the lid opening and closing device 200, the lock support 44 is omitted in the lid 40. On a back surface of the lid 40, an engagement receiver 30 is provided on an upper side of the link shaft 54. In the third embodiment, a receiving recess 30A of the engagement receiver 30 is open to the upper side. A link shaft 54 of a drive-link 52 has a presser 54B, and the presser 54B is configured to be able to press the lock coupling 72 of the lock member 70.

Also in the third embodiment, the lid 40 is positioned outside of an outer panel 80 of a vehicle in an open position, and an opening 82 is open to the outside in the vehicle-width direction. The lid 40 is moved from the open position to the closed position by the link mechanism 50 driven by the actuator 60.

As illustrated in FIG. 10A, in the closed position of the lid 40, the link shaft 54 is disposed outside in the vehicle-width direction of an lower end portion of the lock coupling 72 in the lock member 70. The receiving recess 30A of the engagement receiver 30 is disposed below the hook 74A of the lock member 70. Thus, an unlocked state of the lock member 70 is maintained.

As illustrated in FIG. 10B, in the closed position of the lid 40, the link shaft 54 moves inward in the vehicle-width direction by rotating the drive-link 52 relative to the lid 40 to one side in the direction of rotation by the actuator 60. At this time, the presser 54B of the link shaft 54 presses the lock coupling 72 of the lock member 70 inward in the vehicle-width direction, causing the lock member 70 to rotate clockwise when viewed from the rear side. In other words, the lock member 70 is actuated in conjunction with a relative rotation of the drive-link 52 relative to the lid 40.

As illustrated in FIG. 10C, when the drive-link 52 switches from a lock non-driven state to a locked state, the hook 74A of the lock member 70 is inserted from above into the receiving recess 30A of the engagement receiver 30, and the lock member 70 and the engagement receiver 30 engage in the vehicle-width direction. Accordingly, the lock member 70 switches to the locked state and the lid 40 is prevented from moving outward in the vehicle-width direction.

As described above, in the third embodiment, as in the first embodiment, the lock member 70 can be rotated from the unlocked position to the locked position by utilizing the actuator 60 for opening and closing the lid 40. Therefore, also in the third embodiment, the lid 40 can be locked while controlling a cost increase.

In the third embodiment, the engagement receiver 30 is provided on the lid 40 and the lock member 70 is provided rotatably on the base 20. When switching the drive-link 52 from the lock non-driven state to the lock driven state in the closed position of the lid 40, the presser 54B of the drive-link 52 presses the lock coupling 72, causing the lock member 70 to rotate, and the lock 74 of the lock member 70 engages the engagement receiver 30. This allows the lock member 70 provided on the base 20 to be rotated with a simple configuration to engage the engagement receiver 30 on the lid 40. The invention is not limited to the above embodiments, but can be modified in various ways without departing from the gist thereof.

### EXPLANATION OF THE REFERENCE NUMERALS

10: Lid opening and closing device
20: Base
30: Engagement receiver
30A: Receiving recess
40: Lid
42: Drive-link coupling (coupling)
42A: Coupling groove
52: Drive-link
60: Actuator (driver)
70: Lock member
72: Lock coupling
72A: Slide groove
74: Lock (engagement)
100: Lid opening and closing device
130: Engagement pin (engagement receiver)
170: Lock member
172: Lock
174: Lock coupling
174A: Slide groove
200: Lid opening and closing device

1. A lid opening and closing device comprising:
a base provided inside an opening in a panel of a vehicle;
a lid configured to be movable between an open position in which the opening is opened and a closed position in which the opening is closed;
an engagement receiver provided on one side of the base and the lid;
a lock member provided on other side of the base and the lid, which, when activated in the closed position of the lid, engages the engagement receiver to switch between a locked state in which the lid is prevented from moving and an unlocked state in which the engagement receiver is disengaged from the engagement receiver;
a driver provided inside the panel;
a link whose base-end portion is rotatably coupled to the base and whose tip-end portion is coupled to the lid, and which moves the lid from the open position to the closed position by being rotated around the base-end portion to one side in direction of rotation by a driving force of the driver; and
a coupling provided on the lid and couples the tip-end portion of the link, wherein,
the coupling couples the tip-end portion of the link to the lid so as to allow the link to rotate relative to the lid in the closed position; and
in the closed position, the lock member is actuated by the link that rotates relative to the lid to said one side in the direction of rotation to switch from the unlocked state to the locked state.

2. The lid opening and closing device according to claim 1 wherein;
the coupling has a long hole-shaped coupling groove;
a link shaft is provided at the tip-end portion of the link so as to be integrally rotatable, and the link shaft is movably inserted into the coupling groove and is disposed at one end portion of the coupling groove; and
in the closed position, the coupling groove extends along the direction of rotation of the link shaft, when viewed from axial direction of the link shaft, and the link shaft rotates from said one end portion of the coupling groove to other end when the link is rotated relative to the lid on said one side of the direction of rotation.

3. The lid opening and closing device according to claim 2 wherein in a position other than the closed position of the link, the coupling groove is extended along the direction that intersects the direction of rotation of the link shaft as viewed from the axial direction of the link shaft.

4. The lid opening and closing device according to claim 2, wherein;
the engagement receiver is provided on the base, and the lock member is rotatably provided on the lid;
the lock member comprises a lock configured to be able to engage the engagement receiver and a lock coupling coupled to the link shaft; and
when the link is rotated to said one side in the direction of rotation in the closed position, the lock member is rotated by the link shaft to engage the lock with the engagement receiver in opening direction of the opening, and the lock member is switched from the unlocked state to the locked state.

5. The lid opening and closing device according to claim 4, wherein;
the engagement receiver has a receiving recess into which the lock is inserted;
the lock coupling has a long-hole-shaped slide groove into which the link shaft is inserted so as to be relatively movable; and
in the locked state, the lock is inserted into the receiving recess and engaged with the engagement receiver.

6. The lid opening and closing device according to claim 4, wherein;
the engagement receiver is an engagement pin disposed parallel to the link shaft;
the lock has a lock recess into which the engagement pin is inserted in the closed position, and the lock coupling has the long-hole-shaped slide groove into which the link shaft is inserted so as to be relatively movable;
in the closed position, a center of rotation of the lock member is aligned with a central axis of the engagement pin; and
when the link is rotated to said one side in the direction of rotation in the closed position, the lock member is rotated around the axis of the engagement pin, and the lock engages the engagement pin in the opening direction of the opening and the lock member switches from the unlocked state to the locked state.

7. The lid opening and closing device according to claim 2, wherein;
the engagement receiver is provided on the lid, and the lock member is provided rotatably on the base;
the lock member comprises a lock configured to be able to engage the engagement receiver, and a lock coupling that is pressed against the link; and
when the link is rotated to said one side in the direction of rotation in the closed position, the link presses the lock coupling, which causes the lock member to rotate, and the lock engages the engagement receiver in opening direction of the opening, thereby switching the lock member from the unlocked state to the locked state.

8. The lid opening and closing device according to claim 3, wherein;
the engagement receiver is provided on the base, and the lock member is rotatably provided on the lid;
the lock member comprises a lock configured to be able to engage the engagement receiver and a lock coupling coupled to the link shaft; and
when the link is rotated to said one side in the direction of rotation in the closed position, the lock member is rotated by the link shaft to engage the lock with the engagement receiver in opening direction of the opening, and the lock member is switched from the unlocked state to the locked state.

9. The lid opening and closing device according to claim 8, wherein;
the engagement receiver has a receiving recess into which the lock is inserted;
the lock coupling has a long-hole-shaped slide groove into which the link shaft is inserted so as to be relatively movable; and
in the locked state, the lock is inserted into the receiving recess and engaged with the engagement receiver.

10. The lid opening and closing device according to claim 8, wherein;
the engagement receiver is an engagement pin disposed parallel to the link shaft;
the lock has a lock recess into which the engagement pin is inserted in the closed position, and the lock coupling has the long-hole-shaped slide groove into which the link shaft is inserted so as to be relatively movable;
in the closed position, a center of rotation of the lock member is aligned with a central axis of the engagement pin; and
when the link is rotated to said one side in the direction of rotation in the closed position, the lock member is rotated around the axis of the engagement pin, and the lock engages the engagement pin in the opening direction of the opening and the lock member switches from the unlocked state to the locked state.

11. The lid opening and closing device according to claim 3, wherein;
the engagement receiver is provided on the lid, and the lock member is provided rotatably on the base;
the lock member comprises a lock configured to be able to engage the engagement receiver, and a lock coupling that is pressed against the link; and
when the link is rotated to said one side in the direction of rotation in the closed position, the link presses the lock coupling, which causes the lock member to rotate, and the lock engages the engagement receiver in opening direction of the opening, thereby switching the lock member from the unlocked state to the locked state.
